(19) United States
(12) Patent Application Publication
(10) Pub. No.: US 2014/0285335 A1
(43) Pub. Date: Sep. 25, 2014

(54) SPC

(71) Applicant: Alfred M. Haas, Oakhurst, NJ (US)

(72) Inventor: Alfred M. Haas, Oakhurst, NJ (US)

(21) Appl. No.: 14/216,876

(22) Filed: Mar. 17, 2014

Related U.S. Application Data
(60) Provisional application No. 61/800,936, filed on Mar. 15, 2013.

(51) Int. Cl. G08B 21/24

(52) U.S. Cl. CPC G08B 21/24
USPC 340/500

(57) ABSTRACT

The instant invention is related to methods and means for scheduling and implementing alerts comprising sensory stimuli. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/800,936 (“the '936 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '936 provisional and expressly incorporates by reference the disclosures contained therein in their entirety, including but not limited to all patents, patent applications, and publications which are incorporated by reference in the '936 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system. Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: computers, smart phones, PDAs, other commercially available electronic devices such as tablet PCs, netbooks, e-readers (e.g., Kindle™ and Nook™), pagers, alarms, beepers, cell phones, hearing aids, watches comprising integrated and/or discrete circuits, monitors and displays, televisions, calculators, iPods™ and MP3 players, speakers, microphones, radios and stereos, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, DSPs, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, radio frequency identification (“RFID”) devices, near-field communication (“NFC”) devices, coils, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, and other circuits and systems comprised of circuits.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of some embodiments of the disclosed invention—including, but not limited to software and hardware such as sensors and transducers, circuits, transmitters, receivers, housings, wearable and other mobile devices, programmable logic elements and chips, custom ASICs, electrical and mechanical switches, electrical and mechanical regulators, etc. Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; Principles of Neural Science, Fourth Edition by Kandel, Schwartz, and Jessell, published by McGraw-Hill, copyright 2000; The Pharmacological Basis of Therapeutics, Eighth Edition, by Goodman and Gilman, published by Pergamon Press, copyright 1990; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Elements of Information Theory, by Thomas M. Cover and Joy A. Thomas, published by Willey Interscience, copyright 1991; Information Theory and Reliable Communication, by Robert G. Gallager, published by John Wiley and Sons, copyright 1968; Principles of Communication Engineering, by John M. Wozencraft and Irwin Mark Jacobs, published by Waveland Press, copyright 1965; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; Programming in Objective-C, Fifth Edition by Stephen G. Kochan, published by Addison-Wesley, copyright 2013; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The instant invention is related to methods and means for scheduling and implementing alerts comprising sensory stimuli.

### BRIEF DESCRIPTION OF THE SEVERAL VIEWS OF THE DRAWINGS

### Detailed Description of the Invention

The instant invention is related to methods and means for scheduling and implementing alerts comprising sensory stimuli. Some embodiments of the methods and means of the invention incorporate functionality including, but not limited to communication, sensing, display and data processing elements.

In some embodiments, the methods and means of the invention comprise a system for helping people to remember to perform certain tasks, such as brushing their teeth, eating meals and taking their medicine. One example of an embodiment of a method of the invention comprises the steps of: (1) setting alarms that correspond with particular tasks; (2) a device generating and a user receiving sensory stimuli when those alarms issue; and (3) a user performing the associated tasks. In some embodiments, generated sensory stimuli may comprise light; in some embodiments, generated sensory stimuli may comprise sound; in some embodiments, generated sensory stimuli may comprise vibration or pressure; in some embodiments generated sensory stimuli may comprise some combination of one or more of light, sound and tactile stimulation. In some embodiments, sensory stimuli may be generated by a worn device; in some such embodiments, a worn device may be able to be washed and/or immersed in water so that an individual can shower or bathe without removing it. In some embodiments sensory stimuli may be generated by a hearing aid.

In some embodiments a device for generating sensory stimuli corresponding with issued alarms may further comprise means for directing a user to a vicinity of the site at which a task is to be performed. For example, in some embodiments, a device for generating sensory stimuli—an “alert” device—may generate a tactile stimulus such as a vibration corresponding with the proximity of a user to the vicinity of a set task. In some such embodiments a higher frequency of vibration might correspond with proximity to an appointed task; a lower frequency might indicate a user was further from the desired location. In such embodiments, proximity can be computed and/or inferred in a variety of ways. For example, an RF transceiver may be affixed to something in a vicinity of an appointed task and an alert device may communicate with such a transceiver to ascertain its location and/or the bearing one will need to take to arrive at the prescribed site via e.g. return signal strength, GPS and/or aGPS data, and/or other means such as a programming a map of an area into such a device, along with a means for navigating routes through such an area. Pending U.S. patent application Ser. No. 13/740,767 discloses some means and methods for accomplishing such navigation; the application is hereby incorporated herein in its entirety.

As one specific example of the methods and means of the instant invention, a user's family member, physician and/or caregiver may program a device—in some embodiments, for example a wearable bracelet—to vibrate and light up at times of the day and week corresponding with certain tasks that a user is supposed to perform. In this specific example the wearable bracelet comprises a means for keeping time such as a real-time clock chip and/or a microprocessor using a crystal oscillator, a processing unit with memory, a rechargeable battery, some LEDs, a low-power offset (vibrating) motor, and a communications module. Again in this specific example, software is used to schedule tasks which are transmitted to the wearable bracelet via RF (e.g. Bluetooth, WiFi, and/or other means) and/or wired (e.g. micro-USB cable) means and stored in memory therein. In some such embodiments, software may be run on a desktop computer, a laptop computer, a tablet computer, a cell phone, a Raspberry Pi and/or any other suitable computing device. In some embodiments, a wearable or other device may be programmed directly using inputs to the device, such as buttons and/or microphones for receiving verbal commands. In some embodiments a wearable or other alarm generating device may operate in concert with another device, such as e.g. a cell phone, tablet computer or other device so that the external device (cell phone, tablet, or other device) performs some or all of the scheduling and transmits the set alarms at the appropriate times to the wearable device which conveys the alarm to a user via appropriate sensory stimuli. In some embodiments, alarm times and/or additional data pertaining to the scheduled tasks may be transmitted to the wearable or other sensory stimuli generating device periodically for example on demand as the alarms occur. In some embodiments a cell phone or other programming apparatus transmits alarm scheduling data for certain periods of time all at once.

In some embodiments, a wearable or other device generates an alarm to indicate when it is time to take prescription and/or other medications. In some such embodiments, pills may be placed into one or more containers in advance by a user, a pharmacist, a drug company, and/or another individual such as a family member, physician or friend of a user, and one or more of these containers may comprise an NFC, RFID, and/or other RF tag and/or transceiver so that an individual may (a) locate and/or find the container using via a system comprising a transceiver in a worn bracelet or other device; and (b) identify the medication contained therein via some code which may be optionally stored in memory of an NFC, RFID or other element of such a container. As a more concrete example, a physician may prescribe a suite of several blood pressure medications to a retired woman who can't always remember when to take her medicine and/or which drugs to take at which times. Knowing this in advance, the physician instructs the woman's pharmacist to place her pills in special containers which are like normal medicine vials except the caps comprise NFC tags onto which the pharmacist programs the identity, dosage and scheduling regimen for each drug. Alternately, the physician prescribes a smart pill container comprising several compartments each of which may hold a different drug; such a container may further comprise a processing unit and a means of keeping time, as well as a battery or other power supply, and in some embodiments an LED light on the top of each compartment. In some embodiments, a container can be programmed to illuminate via the appropriate LEDs the compartments corresponding with drugs to be taken at the scheduled times, and/or to disengage the LEDs once the compartments have been opened and the pills taken. As with a wearable alert bracelet, such a container can be programmed by a pharmacist or other individual using a computer or other hardware to store dosage and regimen information in memory of the container, and/or it may operate in conjunction with another device, for example a wearable bracelet and/or a cell phone which can be programmed with regimen and dosage information and which will alert a user to take pills at scheduled times and then communicate such information to the container so that it may signify via LEDs or other signaling mechanism (sound, vibration, etc . . . ) which pills to take at that time. In some embodiments, one or more containers and/or compartments of a container comprise NFC and/or RFID tags; in some embodiments one or more containers and/or compartments of a container comprise an RF transceiver. In some such embodiments a container may be programmed to periodically communicate with an RF transceiver carried and/or worn by a user and the worn and/or carried device may set off an alarm—e.g. lights, sound and/or vibration—in the event the container(s) is separated from the worn and/or carried device by more than a prescribed distance.

In some embodiments, the methods and means of the invention are directed to making sure that an individual does not misplace certain things. In some such embodiments, a worn and/or carried device, for example a bracelet, an amulet, a ring, a hearing aid, a pendant, a cane, a walker, a purse a cell phone and/or any other suitable worn and/or carried device may comprise a communications module capable of detecting when another item is separated from the worn and/or carried device by more than a prescribed distance. In the context of this invention, we shall call such items—i.e. items that we have tagged with a means of locating them with respect to a worn and/or carried device—“bound” items. For example, a user might attach a locator tag to her keys, her medicine container, her checkbook, and her pocketbook and might further wear a smart bracelet according to an embodiment of the instant invention. In some embodiments, locator tags comprise RF transceivers—for example battery-powered Bluetooth modules, WiFi circuits, or other proprietary or open RF transceivers, NFC tags, RFID tags, and/or custom circuits for communicating wirelessly. In some embodiments, locator tags comprise magnets whose absence can be detected e.g. by Hall effect sensors, for example in a purse. In the case of RF transceivers, a wearable bracelet or other locator device comprising an RF transceiver can (a) detect the proximity of tagged items to the locator device; and (b) assist a user to find the device when it is in range of the transceiver. In some embodiments, a worn and/or carried device may periodically check to ensure that all bound items are within prescribed distance of the worn and/or carried device. In some embodiments a worn and/or carried device may check to ensure that all bound items are within a prescribed distance only upon the occurrence of a triggering event, for example crossing a threshold such as an apartment door, or exiting a vehicle. In the specific case of a purse or a wallet, such items may be tagged with longer range lower frequency RF transceivers and/or GPS units to enable tracking a missing item from greater range. Likewise it is be possible to Lo-jack your purse and/or wallet by concealing within it (e.g., sewed inside a lining and/or a handle) an encoded tag which optionally comprises an RF transceiver.

In some embodiments, the methods and means of the invention are designed to help individuals adopt and/or reclaim a normal routine, rather than combat memory loss. In such embodiments, various tasks may be programmed into a device—from the mundane—like brushing one's teeth or bathing, to the more exotic, such as getting on a tour bus to take an annual trip to Atlantic City. Operating in conjunction with a cellular device and/or GPS system, a wearable device, a cane, a walker, a pair of shoes or other device may help guide a user to the appropriate destination at the appropriate time. For in-house tasks such as bathing, brushing one's teeth, doing dishes, paying bills, watching a favorite television program, etc . . . a user may tag the relevant items with a low-cost, low-power RF transceiver (e.g. comprising the latest Bluetooth low-energy hardware and stack) and a worn smart device can direct the user to find such tags at scheduled times. When items were found and employed and/or a task completed a user can disengage or turn off the alarm; in some embodiments an alarm is disengaged automatically within a prescribed period of coming into proximity of the relevant tag for some time; in some embodiments apparatuses such as toothbrushes comprise RF transceivers which may themselves communicate when a task had been completed. Likewise for other household appliances.

In some embodiments a locator device may comprise a pair of shoes. For example, shoes—including but not limited to all forms of footwear such as boots, sandals, flip flops, high heels, sneakers, etc.—may operate in concert with a GPS unit and/or themselves comprise GPS circuits. In some embodiments a shoe comprises hardwear for mapping the route a user has taken while wearing them, thereby enabling the user to retrace his steps and ensuring he does not get lost. Mapping may be accomplished in any number of ways, for example via GPS tracking or by using 3D accelerometers in each shoe to provide a processing unit with piecewise displacement vectors that can be assembled into a map. In some embodiments, such tracking shoes further comprise vibrating motors and/or other sensory stimulating components so as to direct a user according to a prescribed route, to a route dictated by a mobile device such as a cell phone, to the nearest police station, or home simply by vibrating and/or lighting up the shoe in the desired and/or away from the desired direction.

In some embodiments, an RF transceiver comprises a Bluetooth module; in some embodiments an RF transceiver comprises a WiFi module; in some embodiments, an RF transceiver comprises a proprietary, commercially available module, for example one of TI's™ sub-1 GHz CC1000 family chips or a proprietary 2.4 GHz module such as the CC2500 family of RF transceivers. These are illustrative examples and not intended to limit the invention—transceivers according to some embodiments of the invention may be manufactured by other companies than TI™, employ other frequencies (as permitted by law) than the bands enumerated above, and may comprise custom circuits fabricated to spec by a foundry. In some embodiments of the invention, communications modules comprise an RF transceiver and an antenna. According to some embodiments of the invention, an antenna comprises an integrated antenna; in some embodiments an antenna comprises a wire; in some embodiments an antenna comprises a conductive polymer.

In some embodiments, proximity between a user and an appliance, device, or other apparatus may be deduced from the RF signal strength between a transceiver on a smart band, ring or other device and a second transceiver associated with the appliance, device or other apparatus.

In one example of an embodiment, a transceiver associated with an appliance, device, or other apparatus may periodically “ping” a device, such as an RFID device worn by the individual, for example in a band, ring or other accessory or small piece of apparel, and the transceiver may engage the device worn by the individual to detect the proximity of the wearer to the switch. The worn device may be an active device such as a transceiver, or it can be a passive device. If the worn device is an active device, it may periodically pin the aforementioned transceiver as well. If the device worn by or associated with a user is a passive device such as an alloy of metal, a coil wire, or an encapsulated radioactive isotope, it may in some embodiments simply use SONAR, RADAR, X-rays, a Geiger or a like detector system to determine the relative location of that worn device. Similarly, in some embodiments, means for monitoring the presence of an individual in some proximity to a device may be an optical device such as a video camera, CCD, or active pixel sensor.

In some embodiments, a switch, appliance, device or other apparatus may be set to not turn on until and unless the user physically actuates an element of a worn or carried device such as a bracelet or key-chain that may be physically connected to the user. For example, a senior citizen's electric range might be programmed to not turn on until she first puts on and closes a bracelet about his or her wrist thereby releasing the power to the appliance.

In some embodiments of the invention, a smart device is a portable and/or wearable device comprising a communications module. In some embodiments a smart device may comprise a processing unit, a power supply and one or more means for generating and/or transmitting a signal. As a specific example of such an embodiment, a smart device may comprise a microcontroller, an RF communication module (e.g. Bluetooth or WiFi chip+antenna), rechargeable batteries, and a speaker. Communications between a smart device and another smart device, a computer, another device, a user, and/or a network may be by wired or wireless transmission means, although RF such as Bluetooth and WiFi are ubiquitous in cell phones and so provide an easy means of local wireless communication without the need for an individual seeking to use the system to purchase any additional hardware—he or she can simply download an app and then communicate accordingly.

In some embodiments, a user of the instant invention may be a person; in some embodiments a user may be an agent, human or otherwise (e.g., a robot, a cell phone application, a hardware embedded algorithm, a clever chimpanzee, etc . . . ), capable of invoking or performing one or more of the methods and/or employing one or more of the means of embodiments of the instant invention.

In some embodiments, a smart device comprises an NFC tag and/or reader which may be brought in proximity to an NFC reader and/or tag to trigger an event; such an event might comprise an alert, e.g. via SMS, text message, e-mail, or other messaging protocol.

Events may be triggered and alarms may be sounded as a result of a simple threshold crossing or by any number of algorithms or formulas. Algorithms and/or formulas may be implemented by in hardware, software, by one or more human beings, by other entities (think chicken playing tic-tac-toe, or an AI generating optimal path), and/or by some combination of hardware, software and/or one or more human beings or entities. Adaptations and/or changes to formulas may be deterministic, stochastic, and/or determined by a neural network or AI, and may be a function of feedback which feedback may be generated or occur automatically, may be generated by a user, or otherwise.

Some embodiments of the invention comprise a global positioning system (“GPS”) device. Some embodiments of the invention comprise sensors including for example, optical sensing means such as an active pixel camera. In some embodiments, a smart device may comprise a cell phone and/or software. In some such embodiments, a cell phone may be used either independently or in conjunction with other hardware, software, and/or entities to locate entities, places and/or things. In some embodiments a smart device may be in a vehicle. In some embodiments, a smart device comprises a cane. In some embodiments a smart device comprises crutches and in some embodiments a smart device comprises a walker. In some embodiments, a smart device comprises a pair of shoes, including all forms of footwear. In some embodiments a smart device comprises other clothing. In some embodiments a smart device comprises other hardware, including for example but not limited to an iPad, a tablet PC, an other computer, and/or a network of hardware and/or software.

In addition, in some embodiments, a device comprising software and/or hardware can be programmed and/or built to periodically poll, ping, survey or otherwise communicate with other devices, with sensors, with a network server, with a local hot spot, with markers, with beacons, and/or with other software and/or hardware in a vicinity. There are many other ways in which some embodiments of the invention may be realized, including, but not limited to computer hardware devices which communicate with entities possessing compatible devices via RF, IR, or other electromagnetic or optical or sonic transceivers, or networked devices such as smart cell phones communicating on a dedicated frequency band or bands, or through the internet.

In some embodiments of the invention, processing units comprise microcontrollers. In some embodiments, a processing unit may comprise one or more of a display driver, speaker drivers, input channels, power conditioning circuits, memory, and power supply regulation circuitry. In some embodiments, a processing unit may comprise additional hardware and/or software for performing other functions including but not limited to processing and transmitting data, processing and transmitting power, storing and retrieving data, receiving and decoding voice commands, generating signals including but not limited to text, graphics, and speech, as well as for such miscellaneous functions as, e.g. waking and sleeping. In some embodiments, a processing unit comprises custom integrated circuits; in some embodiments the processing unit comprises discrete circuits. In some embodiments, a processing unit comprises a combination of hardware and/or software.

In some embodiments of the invention, a processing unit comprises a communications module—for example, a transceiver with antenna for communicating with other circuits, components, devices, systems, networks and individuals. In some embodiments, a communications module may be used to transmit and receive data such as, e.g. a signal from an RF transmitter, digital GPS coordinates, sensor data, firmware and software updates, as well as other data (e.g., the time and date, weather conditions, etc . . . ). In some embodiments, a communications module may comprise an antenna and/or coil for transmitting and/or receiving EM signals. A communications module may be integrated with the processing unit and/or comprise a separate component that may in some embodiments communicate with the processing unit. A communications module may communicate wirelessly along one or more wavelengths of the electromagnetic spectrum, including but not limited to, radio waves, IR, and visible light (e.g. via radio transceiver, IR transceiver, other coded and/or modulated light transmissions, etc . . . ). It may also communicate via wires, for example using one of a variety of USB cables. In addition, a communications module may include speakers and/or microphones and associated circuits for receiving and decoding voice commands and for generating sounds, including but not limited to speech. A communications module may also be integrated with the power supply—for example by capturing, harvesting and/or storing ambient or transmitted energy from an EM signal. A communications module may, in some embodiments, comprise an RF transceiver core.

Some embodiments comprise means for communicating information to a user. For example, some embodiments comprise means for producing vibration and/or low frequency compression waves, such as vibrating motors. Some embodiments may comprise one or more lights, including but not limited to arrays of lights such as an LCD or LED display. For example, some embodiments comprise OLED (organic light emitting diode) screens like those found in modern cell phones and tablet PCs. However, as used in the context of this invention, displays are not intended to be limited to a single or even to existing technology—additional examples of displays comprised, but were not limited to, the following: liquid crystals, thin film transistors, incandescent lights, fluorescent lights, halogen lights, light emitting diodes, organic light emitting diodes, lasers, fiber optics, color-changing polymers, pigmented fluids, solutions and mixtures, functionalized micro-beads, and e-inks.

In some embodiments, a smart device may operate in conjunction with and/or be capable of transmitting data to and/or receiving data from an external device, system, or network using wires and/or wireless transmission methods. Illustrative examples of external devices comprise, but are not limited to, home alarms, cell phones, tablet computers, PDAs, e-readers (e.g. Kindle™ and Nook™ ), hearing aids, laptop and desktop computers, monitors and displays, televisions, calculators, iPods™ and MP3 players, radios and stereos, watches with electrical circuits, remote controls, bar code readers, keyboards, cameras, other input devices, data acquisition systems, other electrical devices comprising, e.g., microcontrollers, programmable interface controllers, digital signal processors, memories, field programmable gate arrays, discrete circuits, and other electrical circuits and hardware, including custom application specific integrated circuits (ASIC). In some embodiments of the instant invention, portions of residences and/or commercial establishments having appropriate circuitry (e.g. microcontrollers, DSPs, transceiver modules, input devices, etc . . . ) may comprise external devices and/or systems as defined herein. In addition, the world-wide-web, the Verizon™ wireless 4G LTE™ cellular network, and LANs are three illustrative examples of networks.

A smart device and/or tag according to some embodiments of the instant invention may obtain data via wireless transmission between hardware (e.g. sensors, or an onboard microcontroller, or other processor) external to the device and a transmitter and/or receiver in the device. Another method by which the smart device may obtain data is via wires (which may be metal or other conductive material, such as polymer), having uninsulated portions contacted to one or more surfaces of the smart device and which may be contacted to conductive surfaces or other wires. Rechargeable batteries may be charged by a number of means including but not limited to wirelessly by harvesting EM signals and via wires.

A smart device may comprise software and/or hardware—for example a system comprising a cellular phone running an application (“app”) comprises a smart device according to some embodiments of the instant invention.

In some embodiments, the process of setting and/or invoking an alarm comprises one or more of the following steps: detecting, measuring, recording, receiving, collecting, and/or retrieving data; searching data; detecting a signal and/or an event; registering the existence of condition or event; classifying data; analyzing data; sorting data; estimating likelihoods; manipulating data; processing data; storing data; reading and/or writing data; transmitting and/or receiving data; binning data; reducing the dimensionality of data; discriminating data; comparing data; learning from data; recognizing patterns in data; predicting events based on data; as well as many other forms of analysis, manipulation and other processing of data; switching an appliance, device or other apparatus on or off; actuating an appliance, device or other apparatus; triggering an alert; generating a signal; transmitting a signal; vibrating a transducer; and controlling a display.

In some embodiments, data may be gathered and transmitted by devices possessed and/or employed by users and/or entities. As an example, a pharmacist might have an embedded image sensor in a storefront billboard that can, in conjunction with other software and/or hardware, detect when special needs customers entered the premises, entering them into a queue automatically on recognition. Such data may be transmitted locally for example to other devices in range, to a local server, etc . . . and/or through the internet to one or more servers or other networked hardware and/or software.

In some embodiments, the invention may be practiced on a peer-to-peer network of smart and/or mobile devices, such as cell phones, smart phones, PDAs, netbooks, and/or other portable devices capable of wireless transmission and/or receipt of data. For example, a user may specify selected criteria to an application running on and/or embedded in the hardware of a device, and one or more such devices, possibly in conjunction with additional hardware and/or software (e.g., PCs, smart billboards, savvy traffic lights with integrated transmitters and/or receivers, etc . . . ) may be used to practice some embodiments of the methods of the invention.

In some embodiments of the invention, data including but not limited to sensor updates may be transmitted to a smart device periodically. In some embodiments, data may be transmitted to a smart device on the occurrence of an event, such as a user pressing a button, starting a car, or turning a vehicle off and locking a home, an enclosure or a car.

In some embodiments of the instant invention, a user may transmit data to a smart device via an input means. Examples of input means for some embodiments of the instant invention include, but are not limited to, bar code readers and other optical input devices; real, touch and virtual keyboards; RFID tag detectors and/or decoders; radio, IR, visible light and/or other EM transmitters and/or receivers, microphones and decoding systems for spoken words, microphones and decoding systems for sound transmissions other than spoken words, optical sensors (including cameras and associated classification hardware and/or software), chemical sensors (e.g. to detect alcohol or other readily identifiable chemical compounds), as well as advanced scientific instruments (e.g. mass spectrometers, DNA sequencing instruments, NMR machines, etc . . . ). Input means may be a part of a smart device, may be physically and/or electrically attached to a smart device, and/or may be separate from a smart device.

It is possible to perform the steps of storing, processing, transmitting, receiving and/or displaying or otherwise outputting data or other information using a smart device in many ways. In some embodiments, one or more of the steps of setting and/or invoking a task alarm may be performed by some combination of software and/or hardware without human supervision or assistance. Some automated and other embodiments may require that a human user invoke the method in some fashion, e.g., by docking the smart device with a scheduling station, turning a device on, running an application, clicking a button or tapping a smart device, speaking a command, etc., and some automated and other embodiments may perform without a human user explicitly invoking the method. For example, a system may be programmed (in software and/or hardware) to begin operation upon the occurrence of some triggering event or events and/or the satisfaction of one or more conditions. In a more specific example, a smart phone application can be programmed to automatically cut the engine of a vehicle once a user arrived at a scheduled destination.

Other embodiments of the method may be partially automated, with some aspects of the method performed by software and/or hardware, and other aspects performed by or in conjunction with one or more individuals. As an example, a human user may enter criteria into a GUI on his smart phone which is then transmitted wirelessly according to a protocol to a system comprising software and/or hardware, such as a computer server running a program, that to collect, monitor and/or analyze data (e.g., criteria, locations, sensor readings, other data etc . . . ) from one or more users, entities and/or other sources, to tailor a hotel room's climate to an individuals' preferences and interest.

In addition, there are some embodiments where one or more of the steps of the invention is performed by one or more individuals, using data obtained from, provided by and/or generated by hardware and/or software systems. Some embodiments in which the steps of the method are performed by one or more individuals may involve a service component, but such methods do not preclude the use of technology, for example, to act as gatekeepers. As a specific example of such an embodiment, a smart band might detect that a user was about to leave a residence while an oven remained on and suggest the user turn the appliance off; a user cooking a crockpot meal at low temperature over several hours might ignore the suggestion and disable the safety measure to leave the residence and go shopping. A remote operator could likewise perform the same functions at her discretion. As another specific example, a pharmacist might send a text message to user's cell phone or computer indicating the user's prescription was available and remotely adding a task of picking up said prescription from the pharmacy. In such embodiments, although software and/or hardware might be used to perform one or more of the steps of the method of the invention, one or more human operators might also perform some of the steps.

In some embodiments of the invention, measured, ascertained and/or computed data may be transmitted and/or received by and/or retrieved by a smart device and/or other system comprising software and/or hardware. Such data may include, for example, but is not limited to: absolute location information, e.g. GPS coordinates; relative location information, e.g. grid coordinates; the distance or proximity between an entity, place or thing and a user and/or a device worn, carried by, or otherwise proximate to a user; the relative location of an entity, place or thing with respect to a user and/or to a device proximate to a user; the date; the time; environmental conditions such as weather, temperature, humidity and altitude; and other data relevant to some embodiments of the methods and means of the invention, Individual users and/or entities may elect to transmit or to have certain data concerning themselves transmitted to and/or retrieved by such a system. In some embodiments, a smart device and/or other system may ascertain data by one or more means including for example, but not limited to, measuring it, generating or observing it (e.g. pseudo-random numbers), retrieving it from memory, receiving it from users and/or entities via an input means, receiving it from external devices, software and/or hardware, including storage media; receiving it through a network such as the world-wide-web, retrieving it from publicly accessible or private disclosed records, extracting it from software and/or hardware employed by a user and/or entity, sensing it, and/or from any other accessible source. In addition, in some embodiments, a database or collection of data pertaining to users, things, entities and/or locations may be maintained (e.g., on the hard drives of a network server or other hardware), which could ease the computational and/or bandwidth load for the system so that only data which changed, e.g. user/entity/thing location, might be transmitted and/or detected on a repeated basis.

In some embodiments of the invention, transmission and receiving may be by an existing wireless digital protocol (see below), by a custom or future wireless protocol, by analog radio frequency or other EM spectrum (including but not limited to visible, IR, and UV light) transmission, by sound, or any other means of wireless transmission, or via wires, cables, and transferable storage media such as flash drives and data cards.

Various embodiments of the invention may be practiced in many ways, including for example, but not limited to, in real-time, continuously, periodically, regularly, on a schedule, at some prescribed intervals or times, with a given refresh and/or update rate, clocked, and/or asynchronously in an event-driven fashion. Event-driven broadly means triggered by or otherwise correlated in time or sequence with the occurrence of an event. Events include, but are not limited to, the detection of an entity, place and/or thing meeting certain criteria and/or satisfying certain conditions, the recognition that an entity, place and/or thing meets certain criteria and/or satisfies certain conditions, an entity crossing a threshold such as a boundary between a vicinity and an area outside that vicinity, the satisfaction of one or more environmental or other conditions, reaching a detected threshold value or level, the occurrence of something, a change in state, and other occurrences.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A method for scheduling and implementing alerts comprising the steps of: (1) scheduling one or more alerts and (2) generating sensory stimuli corresponding with scheduled alerts.

2. The method of claim 1 further comprising the steps of establishing a rule for scheduling and/or invoking alerts.

3. The method of claim 2 wherein the rule schedules and/or invokes an alert depending on whether a condition has been satisfied.

4. The method of claim 2 wherein the rule schedules and/or invokes an alert depending on whether an event has occurred.

5. A smart device comprising hardware.
